(19) United States
(12) Patent Application Publication
(10) Pub. No.: US 2014/0097607 A1
(43) Pub. Date: Apr. 10, 2014

(54) TEMPORARY TATTOO WITH RACE GUIDE ELEVATION MAP SYSTEM, AND METHOD OF NAVIGATING ELEVATION TERRAIN ON A RACECOURSE

(71) Applicant: Trent Beachy, Golden, CO (US)

(72) Inventor: Trent Beachy, Golden, CO (US)

(21) Appl. No.: 14/050,065

(22) Filed: Oct. 9, 2013

Related U.S. Application Data
(60) Provisional application No. 61/711,450, filed on Oct. 9, 2012.

(51) Int. Cl. G09B 29/00

(52) U.S. Cl. CPC G09B 29/003
USPC 283/34

(57) ABSTRACT

There is disclosed a race guide elevation map system for navigating elevation terrain on a racecourse. In an embodiment, the system includes a temporary tattoo carrying an elevation map disposed thereon, the elevation map having distance demarcations in combination with elevation data. The system further includes a location input such as, for example, an elapsed-distance input, an elapsed-time input, or a coordinate input. The elevation map is configured to provide the athlete with the elevation terrain on the racecourse based on the location input. There is also disclosed a method of navigating elevation terrain on a racecourse. In an embodiment, the method includes affixing a temporary tattoo carrying an elevation map having distance demarcations in combination with elevation data. The method further includes receiving a location input to provide the athlete with the elevation terrain on the racecourse.

### REFERENCE TO PENDING PRIOR PATENT APPLICATION

This application claims the benefit under 35 U.S.C. 119 (e) of U.S. Provisional Patent Application No. 61/711,450, filed Oct. 9, 2012 by Trent Beachy for “TEMPORARY TATTOO WITH RACE GUIDE ELEVATION MAP SYSTEM, AND METHOD OF NAVIGATING ELEVATION TERRAIN ON A RACECOURSE,” which patent application is hereby incorporated herein by reference.

### BACKGROUND

Generally, athletes who compete in events such as, for example, marathons, road or mountain bike races, triathlons, and trail running races desire a way to track their progress along the racecourse. The ability to track one's progress in relation to key access points along the course allows an athlete to manage his or her progression through the race. For example, an athlete who knows his or her position in relation to upcoming terrain, water or food stations, crewing stations, turnarounds, aid stations, and other important points along the course, may better plan for proper pacing and/or energy outlay, hydration, nourishment, first aid, equipment maintenance, and/or other crucial race functions.

In many instances, athletes are forced to carry maps of the racecourse. In situations where race conditions make it difficult or impossible to carry and access bulky maps or notes on the go, athletes often resort to applying stickers that depict the racecourse or even drawing the racecourse directly onto their skin. These maps, stickers, notes, and/or drawings of the racecourse may then be combined with known time and/or distance information relating to the athlete, which allows the athlete to understand his/or her position along the course and manage his or her progress accordingly.

The current mechanisms for carrying racecourse data along the route render race management difficult. External maps and notes are bulky and difficult to access on the go. Stickers peel, fade, and crack and are vulnerable to often unavoidable elements such as moisture (e.g., rain, snow, sweat), heat, and cold, and freehand maps drawn directly onto the skin are inaccurate and lack detail.

While temporary tattoos have been utilized for many purposes in the past, temporary tattoos have not been used for navigating elevation terrain on a racecourse.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

One embodiment provides a race guide elevation map system for navigating elevation terrain with respect to elevation terrain on a racecourse. The system comprises a temporary tattoo carrying an elevation map disposed thereon, the elevation map having distance demarcations in combination with elevation data, and a location input received from outside the temporary tattoo. The elevation map is configured to provide an athlete with the elevation terrain on the racecourse based on the location input.

Another embodiment provides a method of navigating elevation terrain on a racecourse. The method includes the step of affixing, onto the skin of an athlete, a temporary tattoo carrying an elevation map disposed thereon, the elevation map having distance demarcations in combination with elevation data. The method also includes the step of receiving a location input from outside of the temporary tattoo, wherein the elevation map is configured to provide the athlete with the elevation terrain on the racecourse based on the location input.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1A illustrates an exemplary embodiment of a temporary tattoo with a race guide elevation map system after application to the skin of an athlete;

FIG. 1B illustrates the temporary tattoo of FIG. 1A before application to the skin of an athlete;

FIGS. 2A-12B illustrate numerous exemplary embodiments of temporary tattoos, each with a race guide elevation map system, shown after application to the skin of an athlete and before application to the skin of an athlete;

FIG. 13 illustrates one embodiment of a labeled bag for storing and distributing a temporary tattoo with a race guide elevation map system of FIGS. 1A-12B; and

FIG. 14 illustrates one embodiment of a set of application instructions for applying a temporary tattoo with a race guide elevation map system of FIGS. 1A-12B.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

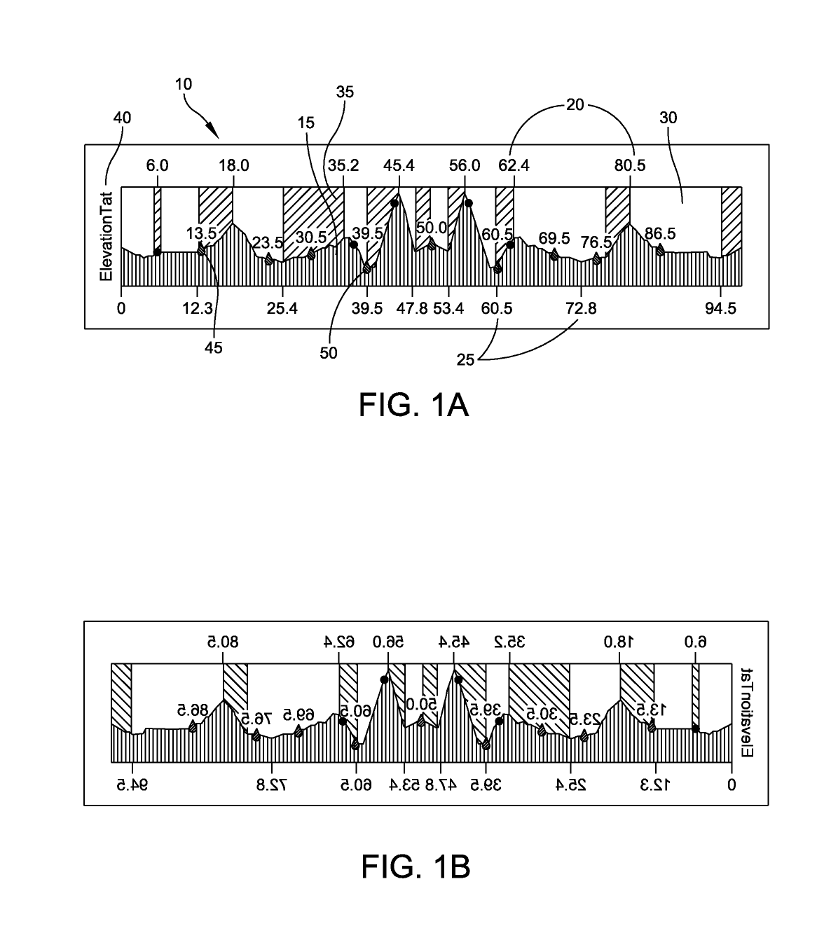

FIGS. 1A-B show one embodiment of a temporary tattoo 10 with a race guide elevation map system. Temporary tattoo 10 is shown both as applied to the skin of an athlete (FIG. 1A) and as a mirror image presented before tattoo 10 is applied to the skin of an athlete (FIG. 1B). In this embodiment, an elevation map 15 may be provided within temporary tattoo 10. Elevation map 15 may include various types of data, or facts, which may become information when seen in context such that they convey meaning to the athlete.

In one embodiment, a GPS watch (not shown) or other GPS device may be used to provide an external location input to the athlete. For example, the device may be used to notify the athlete directly of his or her position along the racecourse (e.g., via location coordinates) or of the distance that has elapsed since the athlete's starting position. If the athlete is provided with a measurement of elapsed distance, the athlete may use this information to determine his or her relative place on the racecourse by comparing the map to indicators such as aid, water, or crewing stations along the course or to other signage on the course such as mile markers or time clocks.

Using this comparison, the athlete may apply map 15 to navigate the course most efficiently. For example, the athlete may use map 15 to plan upcoming rest points for hydration and/or food or to adjust his or her pace according to the distance traveled verses the time elapsed or to the upcoming level of difficulty (e.g., elevation gain), etc.

A number of distance demarcations 20, 25 may be provided on elevation map 15. In FIGS. 1A-B, distance demarcations 20 running across the top of map 15 illustrate points of relative high altitude with respect to the neighboring portions of the racecourse. In another embodiment, demarcations may be provided on other portions of the elevation map.

Distance demarcations 25 running across the bottom of the map illustrate points of relative low altitude with respect to neighboring portions of the racecourse. In another embodiment, demarcations may be provided on other portions of the elevation map.

Color-coded regions 30 may be provided on various portions of map 15. In this embodiment, color-coded regions 30 are shown in white, or without shading. These white areas, or non-shaded regions 30, illustrate portions of the racecourse in which there is generally downwardly progressing terrain (i.e., the racecourse is generally downhill in these regions.)

Color-coded regions 35 may also be provided on various portions of map 15. In this embodiment, color coded regions 35 are shown shaded. These shaded areas, or shaded regions 30, illustrate portions of the racecourse in which there is generally upwardly progressing terrain (i.e., the racecourse is generally uphill in these regions). While regions 30, 35 are shown as non-shaded and shaded, respectively, these selections are demonstrative only. Embodiments of map 15 may include any appropriate color indexing. For example, embodiments of map 15 may employ color coding that corresponds to the official colors of a particular race or to any other applicable factors that influence the aesthetics of temporary tattoo 10.

By referring to color-coded regions 30, 35, the athlete may more easily plan an appropriate amount of effort outlay over the duration of the course. That is, non-shaded (generally downwardly) regions 30 and shaded (generally upwardly) regions 35 make it easier for the athlete to plan for less or more effort, respectively, over appropriate segments of the racecourse.

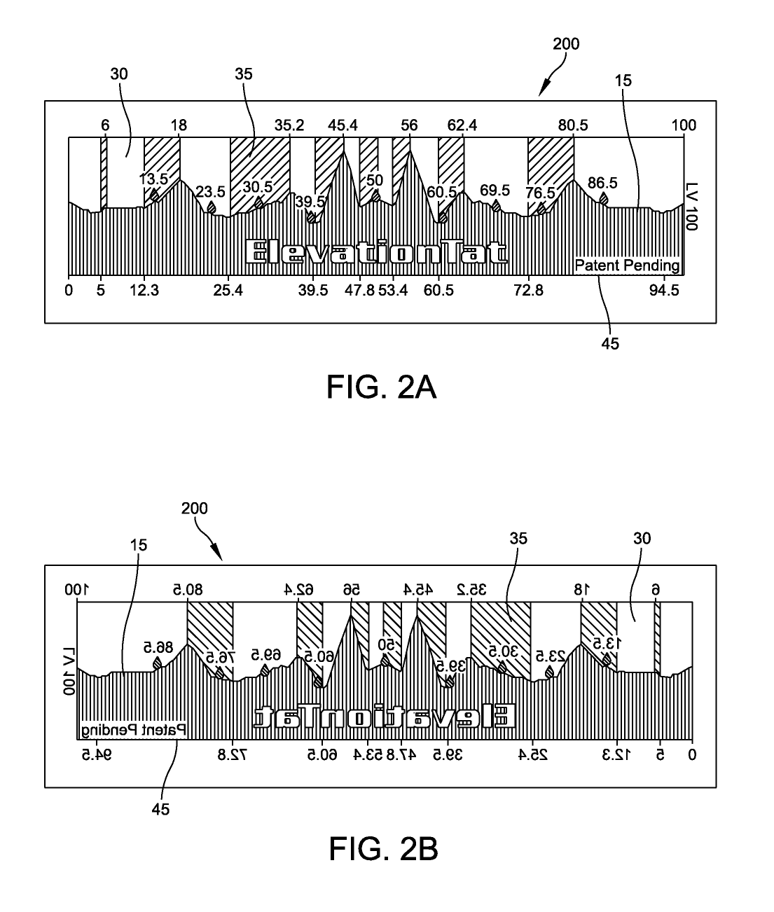

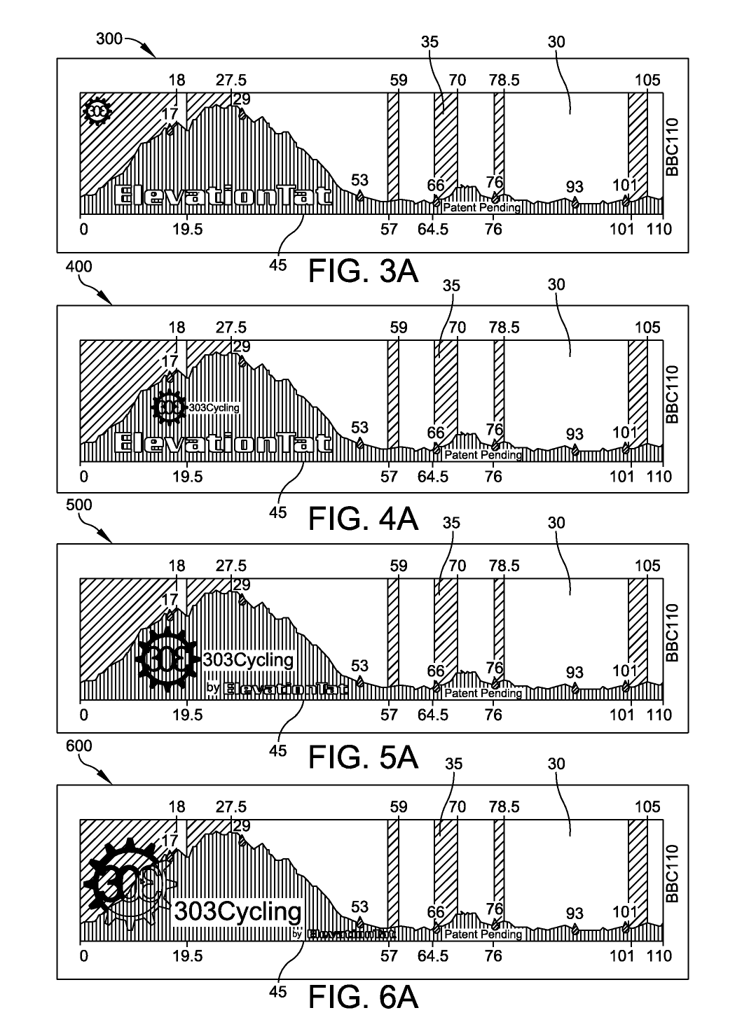

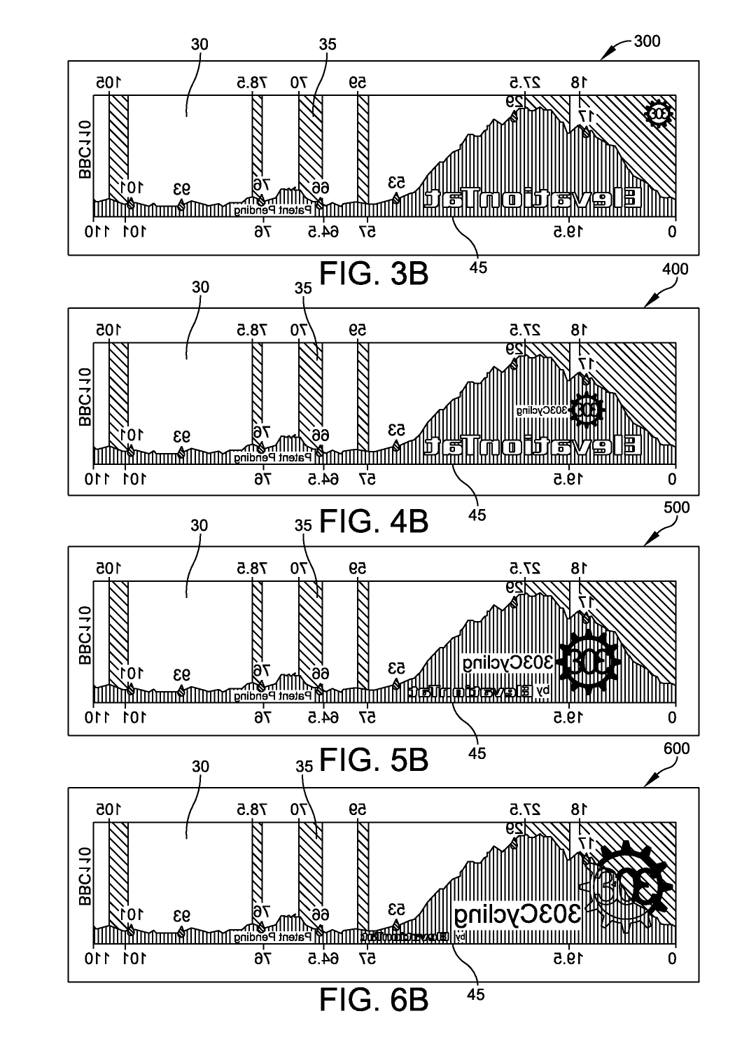

Promotional badging or branding may be provided on various portions of the temporary tattoo. For example, FIGS. 2A-B illustrate an exemplary embodiment a temporary tattoo 200, which features the brand ElevationTat extended across a base region 45 of temporary tattoo 200. Moreover, temporary tattoos 300, 400, 500, 600, shown in FIGS. 3A-6B, provide numerous additional branding sequences that feature the brand ElevationTat as well as the brand and logo 303 Cycling. Each of temporary tattoos 200-600 is shown as applied to an athlete's skin (FIGS. 2A-6A) and as a mirror image presented prior to application to an athlete's skin (FIGS. 2B-6B).

In other embodiments, promotional badging or other advertising material may be disposed in any appropriate position within the design of the temporary tattoo, including within color-coded regions 30, 35, base region 45, or any other appropriate portion of the temporary tattoo. The badging or advertising material may include any badging or other data that may be turned into information or monetized by race promoters, sponsors, or the tattoo designers.

Beyond distance and elevation information, discussed above, the temporary tattoo may detail other points of interest to the athlete. Returning to FIGS. 1A-B, an embodiment of tattoo 10 may depict water stations 50 together with a distance demarcation. As a result, when an athlete receives a location or distance input from an outside source such as a GPS device (not shown) or race signage, the athlete may use that location or distance data to glean useful information about water stations 50 that are near the athlete's position on the racecourse.

Beyond water stations 50, other embodiments of tattoo 10 may depict other points of interest along the course. For example, embodiments of tattoo 10 may depict food stations (e.g., providing energy bars or other energy-intense foods), rest stations, crewing stations, turnarounds, service stations (e.g., stations where tools such as wrenches, tire pumps, etc., are available to address equipment failures), first-aid stations, pacer intervals, and more.

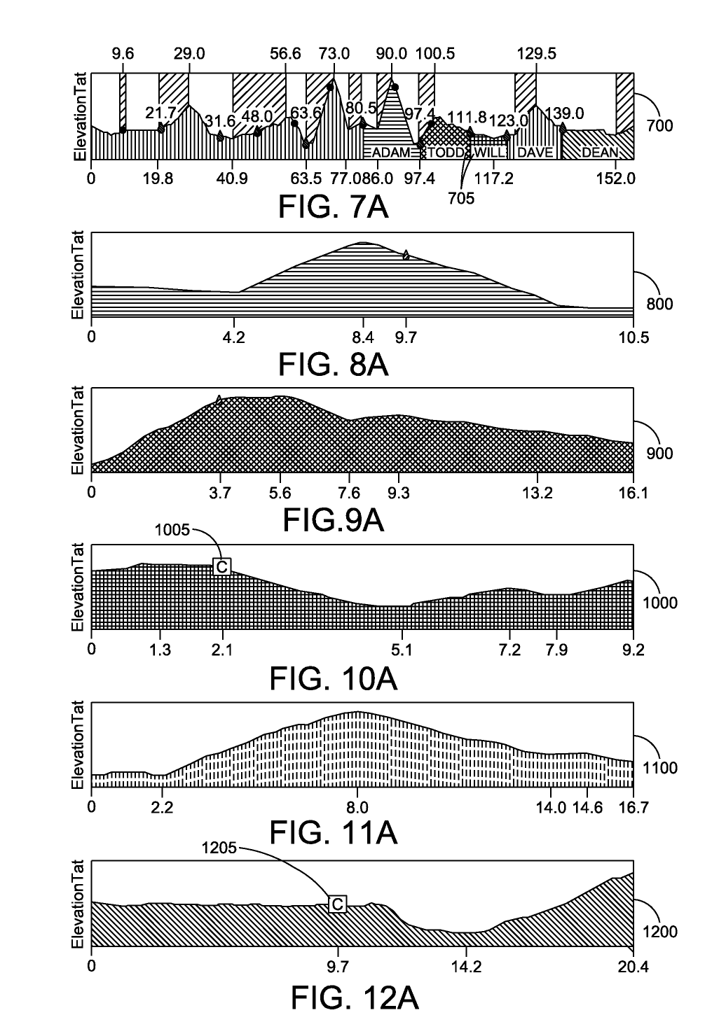

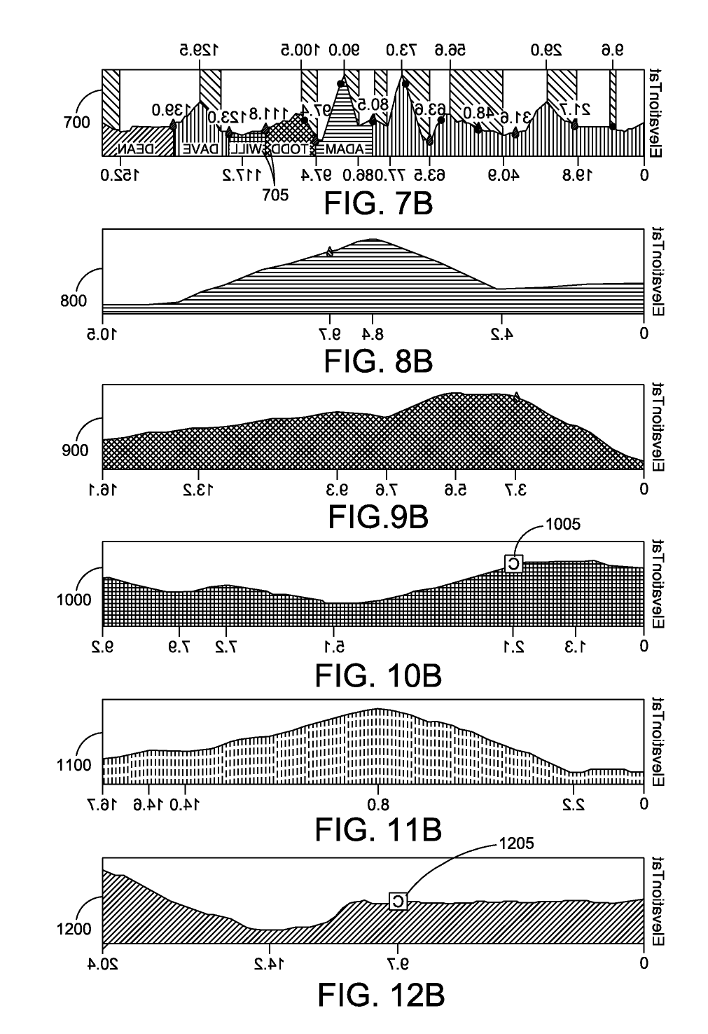

To detail a variety of these additional points of interest, FIGS. 7A-12B illustrate exemplary embodiments of various temporary tattoos 700, 800, 900, 1000, 1100, 1200 with race guide elevation map systems shown both after (FIGS. 7A-12A) and before (FIGS. 7B-12B) application to the skin of an athlete. Each temporary tattoo 700-1200 features a different type of interest point along the racecourse.

For example, FIGS. 7A-B feature sections 705, which are exemplary positions in which specified pacer individuals traverse the racecourse with the athlete wearing temporary tattoo 700 having the race guide elevation map system.

FIGS. 10A-B and 12A-B illustrate crewing stations 1005 and 1205 located at specified locations along the racecourse. In these embodiments, crewing station 1005 is located at a distance of 2.1 kilometers in FIGS. 10A-B, and crewing station 1205 is located at a distance of 9.7 kilometers in FIGS. 12A-B.

FIGS. 8A-B, 9A-B, and 11A-B illustrate shorter races with data provided in a more simplified format. While simplified, temporary tattoos 800, 900, 1100 provide useful information regarding distance, elevation, and/or hydration to the athlete in an elegant format requiring less thought and/or processing, especially when used in combination with GPS data, mile-marker signage along the racecourse, or time clocks along the racecourse.

The temporary tattoo with a race guide elevation map system may be used in conjunction with any appropriate external input relating to the athlete's position or location on the racecourse. Inputs may include, for example, GPS data indicating elapsed distance or a coordinate location, mile-marker signage along the racecourse, or time clocks along the racecourse.

The temporary tattoo provides a superior alternative to a paper map, an adhesive sticker, or an electronic map inasmuch as the typical racer is an athlete who, for reasons relating to speed, performance, and overall comfort, does not want to attach external items to the body, except, perhaps, a GPS watch. The temporary tattoo also provides a superior alternative to writing on the athlete's body with pens or other ink, which is a crude solution that does not provide a comprehensive set of information to the racer as a race guide elevation map system. For example, freehand maps drawn on the body lack distances of incline starts and stops, as well as other fundamental information that the athlete needs in a manner drawn to compact specifications that fit within a temporary tattoo.

By using the temporary tattoo in conjunction with a GPS watch or other GPS device, the athlete may be able to quickly and unobtrusively calculate his or her position on the racecourse. In this vein, a racer can use this system as a tool with a little bit of information (e.g., elapsed distance from the start of the race) to “lookup” relevant data on the map system so as to provide functional information in connection with the athlete's position on the racecourse.

The race guide elevation map system may apply to any type of racecourse-related event or competition. For example, the race guide elevation map system may be configured for a racer as an athlete involved in a running race on a road, trail, or other pathway. In other embodiments, the race guide elevation map system may be configured for a racer as an athlete involved in a bicycling race on a mountain bike or a road bike. The race guide elevation map system may also be configured for a racer as an athlete participating in a triathlon, which includes several different aspects including, for example, but not limited to, swimming, cycling, and running in succession over various distances and terrains.

The sizing of the tattoo is very important, as it must be locatable on the forearm, the inner arm, or the quadriceps area of an athlete to facilitate quick and convenient viewing dependent on the sport in play. For biking races, the race guide elevation map system may be configured for placement on the quadriceps area as well as the forearm (e.g., on a posterior location of the forearm). For running races, the race guide elevation map system may be configured for placement on the forearm (e.g., on a posterior location of the forearm) or other portions of the inner arm (e.g., on a portion of the biceps).

In an embodiment, the race guide elevation map system may be configured for distribution to many (or all) participants in a race. In another embodiment, the race guide elevation map system may be configured as a customized product for a single racer. For example, the specific names of the athlete's pacers are provided in sections 705 of FIGS. 7A-B.

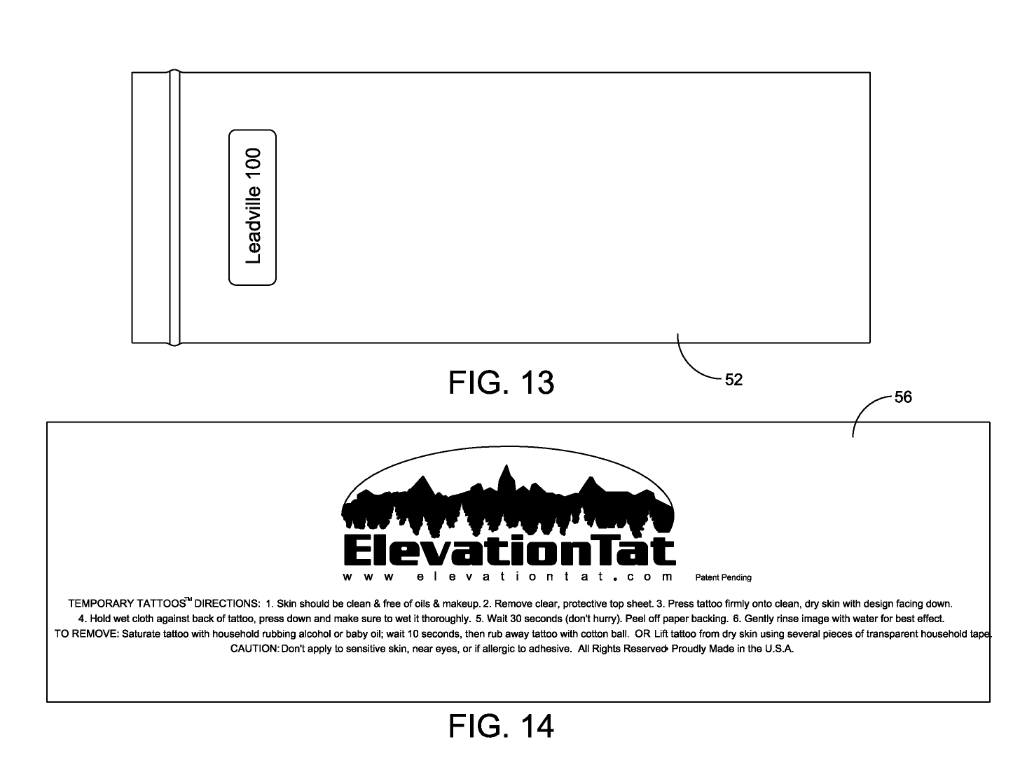

In one embodiment, the race guide elevation map system is a printed temporary tattoo. The temporary tattoo may utilize a substrate and inks well known in the temporary tattoo arts. The temporary tattoo may be distributed within a clear, labeled container or bag that denotes the race to which the race guide elevation map system of the tattoo corresponds. For example, FIG. 13 shows a clear bag 52 designed to protect tattoos for the Leadville 100 race. The tattoo itself may also include a race label 54, as shown in FIGS. 2A-B, in which tattoo 200 includes a printed “LV100” along one side. The label “LV100” corresponds to the Leadville 100 race printed on bag 52. Application instructions 56 may be included with the tattoo within container or bag 52. FIG. 14 shows an exemplary set of application instructions 56.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A race guide elevation map system for navigating elevation terrain with respect to elevation terrain on a racecourse, the system comprising:
a temporary tattoo carrying an elevation map disposed thereon, said elevation map having distance demarcations in combination with elevation data; and
a location input received from outside said temporary tattoo, wherein said elevation map is configured to provide an athlete with the elevation terrain on the racecourse based on said location input.

2. The race guide elevation map system of claim 1, wherein said location input comprises an elapsed-distance input, an elapsed-time input, or a location-coordinate input.

3. The race guide elevation map system of claim 1, wherein said distance demarcations identify points of high altitude.

4. The race guide elevation map system of claim 1, wherein said distance demarcations identifying points of low altitude.

5. The race guide elevation map system of claim 1, further comprising regions identifying uphill terrain.

6. The race guide elevation map system of claim 1, further comprising regions identifying downhill terrain.

7. The race guide elevation map system of claim 1, wherein said distance demarcations identify water stations.

8. The race guide elevation map system of claim 1, wherein said distance demarcations identify crewing stations.

9. The race guide elevation map system of claim 1, wherein said distance demarcations identify multiple pacer intervals.

10. The race guide elevation map system of claim 1, wherein said temporary tattoo is configured for placement on a forearm area of the athlete.

11. The race guide elevation map system of claim 1, wherein said temporary tattoo is configured for placement on a bicep area of the athlete.

12. The race guide elevation map system of claim 1, wherein said temporary tattoo is configured for placement on a quadriceps area of the athlete.

13. The race guide elevation map system of claim 1, further comprising a GPS watch providing said location input.

14. The race guide elevation map system of claim 1, further comprising a GPS device providing said location input.

15. The race guide elevation map system of claim 1, further comprising a distance sign on the racecourse providing said location input.

16. A method of navigating elevation terrain on a racecourse, said method comprising:
affixing, onto the skin of an athlete, a temporary tattoo carrying an elevation map disposed thereon, said elevation map having distance demarcations in combination with elevation data; and
receiving a location input from outside of said temporary tattoo, wherein said elevation map is configured to provide the athlete with the elevation terrain on the racecourse based on said location input.

17. The method of claim 16, wherein said location input comprises an elapsed-distance input, an elapsed-time input, or a location-coordinate input.

18. The method of claim 16, wherein said distance demarcations identify points of high altitude or points of low altitude.

19. The method of claim 16, further comprising first regions identifying uphill terrain and second regions identifying downhill terrain.

20. The method of claim 16, wherein said distance demarcations identify water stations, crewing stations, or pacer intervals.

21. The method of claim 16, wherein said distance demarcations identify crewing stations.

22. The method of claim 16, wherein said distance demarcations identify multiple pacer intervals.

23. The method of claim 16, wherein said affixing said temporary tattoo includes placement on a forearm area of the athlete.

24. The method of claim 16, wherein said affixing said temporary tattoo includes placement on a bicep area of the athlete.

25. The method of claim 16, wherein said affixing said temporary tattoo includes placement on a quadriceps area of the athlete.

26. The method of claim 16, wherein said receiving said location input comprises receiving an elapsed-distance input from a GPS device.

27. The method of claim 26, wherein said GPS device comprises a GPS watch.

28. The method of claim 16, wherein said receiving said location input comprises referring to a distance sign on the racecourse.
